(19) United States
(12) Patent Application Publication
(10) Pub. No.: US 2026/0199951 A1
(43) Pub. Date: Jul. 16, 2026

(54) TOOL, METHOD FOR FORMING ALIGNMENT DEPRESSED PORTION, AND ALIGNMENT STRUCTURE

(71) Applicant: AMADA CO., LTD., Kanagawa (JP)

(72) Inventor: Takuya OKAMOTO, Kanagawa (JP)

(73) Assignee: AMADA CO., LTD., Kanagawa (JP)

(21) Appl. No.: 19/137,958

(22) PCT Filed: Dec. 4, 2023
(86) PCT No.: PCT/JP2023/043244

§ 371 Date: Jun. 11, 2025

(30) Foreign Application Priority Data
Dec. 19, 2022 (JP) 2022-202273

(51) Int. Cl. B21D 22/02; B23K 26/02

(52) U.S. Cl. CPC B21D 22/02; B23K 26/02

(57) ABSTRACT

An alignment structure includes an alignment protruded portion protruded from an end face of a first workpiece, and an alignment depressed portion formed on a surface of a second workpiece such that the alignment protruded portion is entered thereinto and engaged therewith. The alignment protruded portion has a bottom face and an inclined face. A pair of depressed-portion inclined faces whose cross-sectional faces are inclined with respect to a thickness direction, and a protrusion that has a vertical face are formed on the alignment depressed portion that is formed by using a tool and a method for forming the alignment depressed portion by using the tool. The alignment depressed portion is aligned due to an engagement with the alignment protruded portion, in which the inclined face contacts with one of the pair of depressed-portion inclined faces, and thus the first workpiece is aligned with respect to the second workpiece.

### TECHNICAL FIELD

The present invention relates to a tool, a method for forming an alignment depressed portion, and an alignment structure.

### BACKGROUND ART

A Patent Literature 1 discloses a method for welding a corner joint. In the welding method disclosed in the Patent Literature 1, workpieces are aligned and held in a state where they are contacted with each other orthogonally so that an end face of one of the workpieces overlaps a face of another workpiece in a vicinity of its edge, and then a laser beam is emitted to the contacted portion to achieve butt-welding.

### CITATION LIST

### Patent Literature

[Patent Literature 1] Japanese Patent Application Laid-Open Publication No. 2018-187665.

### SUMMARY OF INVENTION

Since the welding method disclosed in the Patent Literature 1 requires the jig associated with shapes or the like of the workpieces, there is room for reducing costs of the jig and the setting time of the jig.

A first aspect of the present invention is a tool comprising: a punch; and a die disposed to be opposite to the punch in a vertical direction, wherein one of the punch and the die has a flat surface portion on a surface facing another thereof, wherein the other has a rib-shaped forming portion that extends long in one direction and protrudes toward the one to have a triangular cross-sectional shape, and wherein a dent portion is formed on one of sloped faces of the forming portion so as to be gouged to form a circumferential face of a cylinder with a vertical axis.

A second aspect of the present invention is a method for forming an alignment depressed portion, by using a tool that includes a punch; and a die disposed to be opposite to the punch in a vertical direction, wherein one of the punch and the die has a flat surface portion on a surface facing another thereof, wherein the other has a rib-shaped forming portion that extends long in one direction and protrudes toward the one to have a triangular cross-sectional shape, and wherein a dent portion is formed on one of sloped faces of the forming portion so as to be gouged to form a circumferential face of a cylinder with a vertical axis, the method comprising: by pressing a metal plate between the punch and the die, forming an alignment depressed portion on the metal plate, the alignment depressed portion having a V-shaped cross-section that corresponds to the triangular cross-sectional shape of the forming portion and a protrusion protruding to have a circumferential face that extends in the vertical direction and is associated with the dent portion.

A third aspect of the present invention is an alignment structure comprising: an alignment protruded portion formed to be protruded from an end face of a first workpiece that is a metal plate; and an alignment depressed portion formed on a surface of a second workpiece such that the alignment protruded portion is entered thereinto and engaged therewith, wherein the alignment protruded portion is formed to have a tapered shape that has a bottom face extending in an expanding direction of the first workpiece and an inclined face inclined with respect to the bottom face, wherein the alignment depressed portion is a depressed portion that extends in one direction to have a given length and whose cross-sectional shape is formed to have a V-shape including a pair of depressed-portion inclined faces inclined with respect to a thickness direction of the second workpiece, a protrusion that has a face extending in the thickness direction being formed in the middle of the length, and wherein the first workpiece is aligned in an orthogonal manner with respect to the second workpiece, while engaging the alignment depressed portion is engaged with the alignment protruded portion, due to an alignment in which the inclined face of the alignment protruded portion contacts one of the pair of depressed-portion inclined faces and the bottom face thereof contacts the face of the protrusion extending in the thickness direction.

A fourth aspect of the present invention is an alignment structure comprising: an alignment protruded portion formed to be protruded from an edge portion of a first workpiece that is a metal plate; and an alignment depressed portion formed on a surface of a second workpiece such that the alignment protruded portion is entered thereinto and engaged therewith, wherein the alignment protruded portion is formed to have a tapered shape that has a bottom face extending in a thickness direction of the first workpiece and an inclined face inclined with respect to the bottom face, wherein the alignment depressed portion is a depressed portion that extends in one direction to have a given length and whose cross-sectional shape is formed to have a V-shape including a pair of depressed-portion inclined faces inclined with respect to a thickness direction of the second workpiece, a protrusion that has a face extending in the thickness direction thereof being formed in the middle of the length, and wherein the first workpiece is aligned in a stacked manner with respect to the second workpiece, while engaging the alignment depressed portion is engaged with the alignment protruded portion, due to an alignment in which the inclined face of the alignment protruded portion contacts one of the pair of depressed-portion inclined faces and the bottom face thereof contacts the face of the protrusion extending in the thickness direction.

According to the tool, the method for forming the alignment depressed portion, and the alignment structure that include the above configurations, respectively, it is possible to reduce costs of a jig and setting time of the jig by enabling alignment of the workpieces for butt-welding without using a jig.

### BRIEF DESCRIPTION OF DRAWINGS

FIG. 1A is a schematic cross-sectional view showing a configuration example of a protruded portion forming tool KD1 for a thin plate to form an alignment protruded portion WcA according to a first embodiment.

FIG. 1B is a partially enlarged view of FIG. 1A.

FIG. 2A is a schematic cross-sectional view showing a configuration example of a protruded portion forming tool KD2 for a thick plate to form an alignment protruded portion WcB according to one aspect of the present embodiment.

FIG. 2B is a partially enlarged view of FIG. 2A.

FIG. 3A is a first schematic plan view for describing the first embodiment in a method for forming an alignment protruded portion Wc.

FIG. 3B is a second schematic plan view for describing the first embodiment.

FIG. 3C is a third schematic plan view for describing the first embodiment.

FIG. 3D is a fourth schematic plan view for describing the first embodiment.

FIG. 4A is a first schematic plan view for describing a second embodiment in the method for forming the alignment protruded portion Wc.

FIG. 4B is a second schematic plan view for describing the second embodiment.

FIG. 4C is a third schematic plan view for describing the second embodiment.

FIG. 4D is a fourth schematic plan view for describing the second embodiment.

FIG. 5A is a schematic cross-sectional view showing a configuration example of a depressed portion forming tool KD3 to form an alignment depressed portion Wd according to the one aspect of the present embodiment.

FIG. 5B is a partially enlarged view of FIG. 5A.

FIG. 5C is a perspective view of a forming portion 32P of the depressed portion forming tool KD3 seen from left front diagonally upward.

FIG. 5D is a schematic cross-sectional view showing a configuration example of a depressed portion forming tool KD3A according to a modification of the depressed portion forming tool KD3.

FIG. 6A is a top view of the alignment depressed portion Wd.

FIG. 6B is a cross-sectional view taken at a position A-A in FIG. 6A.

FIG. 7A is a schematic plan view showing a first step an example of a first method for forming the alignment depressed portion Wd according to the one aspect of the present embodiment.

FIG. 7B is a schematic plan view showing a second step of the example of the first method for forming the alignment depressed portion Wd according to the one aspect of the present embodiment.

FIG. 7C is a schematic plan view showing a third step of the example of the first method for forming the alignment depressed portion Wd according to the one aspect of the present embodiment.

FIG. 8A is a schematic plan view showing a first step of an example pf a second method for forming the alignment depressed portion Wd according to the one aspect of the present embodiment.

FIG. 8B is a schematic plan view showing a second step of the example of the second method for forming the alignment depressed portion Wd according to the one aspect of the present embodiment.

FIG. 8C is a schematic plan view showing a third step of the example of the second method for forming the alignment depressed portion Wd according to the one aspect of the present embodiment.

FIG. 9A is a top view for describing an alignment structure GK in a workpiece Wb of a thick plate.

FIG. 9B is a cross-sectional view taken at a position B-B in FIG. 9A.

FIG. 10A is a top view for describing the alignment structure GK in a workpiece Wa of a thin plate.

FIG. 10B is a cross-sectional view taken at a position C-C in FIG. 10A.

FIG. 10C is a perspective view for describing the alignment structure GK in the workpiece Wa of the thin plate.

FIG. 11A is a partial cross-sectional view for describing an alignment structure GK2.

FIG. 11B is a cross-sectional view for describing a first aspect of the alignment structure GK2.

FIG. 11C is a cross-sectional view for describing a second aspect of the alignment structure GK2.

FIG. 12A is a schematic side view showing a closed corner welding mode to which the alignment structure GK according to the one aspect of the present embodiment can be applied.

FIG. 12B is a schematic side view showing a half-open corner welding mode to which the alignment structure GK according to the one aspect of the present embodiment can be applied.

FIG. 12C is a schematic cross-sectional view showing a welding mode example in the alignment structure GK2.

### DESCRIPTION OF EMBODIMENTS

One aspect of an embodiment will be described with reference to the drawings. In descriptions of the drawings, equivalent components are labelled with identical reference numbers, respectively, and their descriptions will be omitted. For convenience of descriptions, respective directions of up, down, left, right, front, and rear are defined by arrows in each drawing. By the alignment structure GK according to the one aspect of the present embodiment, two metal plate workpieces (hereinafter referred to as the workpieces) are joined in an orthogonal manner by engagement of an alignment protruded portion and an alignment depressed portion. The alignment protruded portion is formed on one of the two workpieces, and the alignment depressed portion is formed on the other.

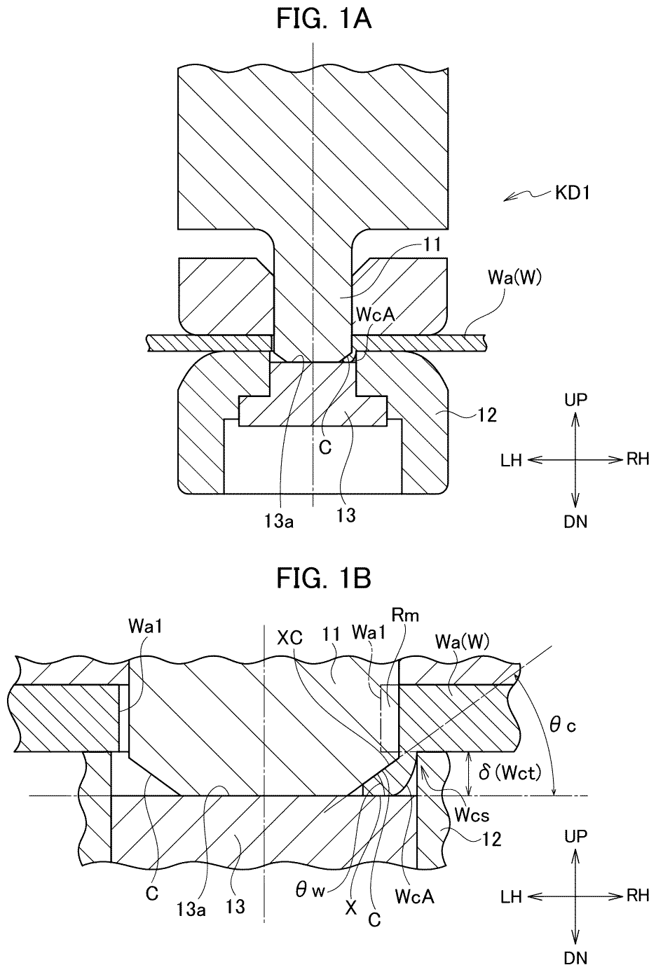

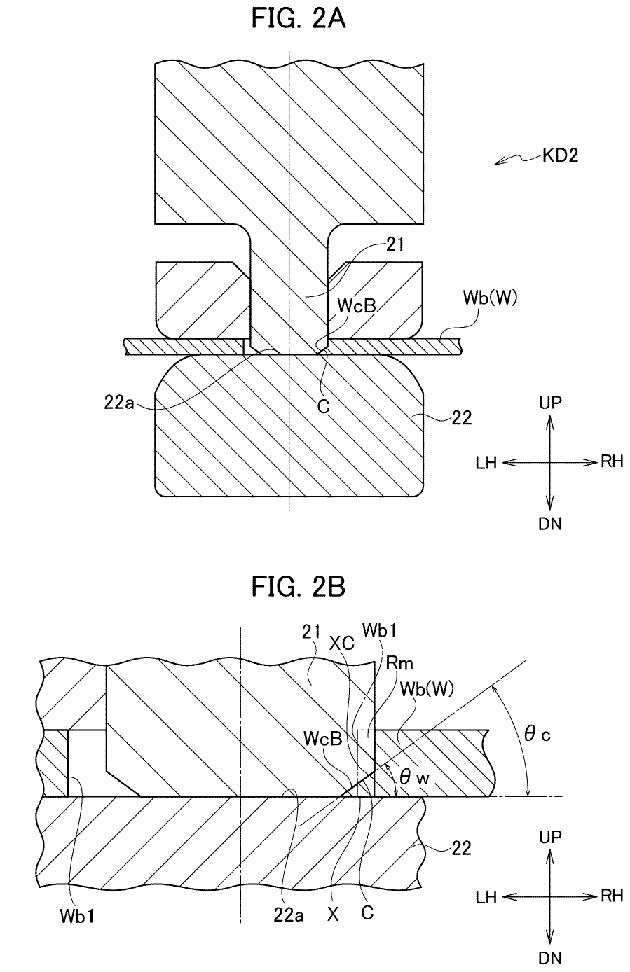

The alignment protruded portion and the alignment depressed portion are formed with a protruded portion forming tool and a depressed portion forming tool, respectively. First, a protruded portion forming tool KD1 for a thin plate and a protruded portion forming tool KD2 for a thick plate to form alignment protruded portions will be described with reference to FIGS. 1A to 2B. A workpiece W is a metallic plate, for example, a steel plate or an aluminum plate. The steel plate is, for example, a cold-rolled steel plate (SPC) or a stainless-steel plate (SUS). In the workpiece W of the Steel plate, a plate thickness t of less than 1.6 mm is defined for a thin plate workpiece Wa, and a plate thickness t of 1.6 mm or more is defined for a thick plate workpiece Wb. The protruded portion forming tool KD1 for a thin plate is used in processing the thin plate workpiece Wa, and the protruded portion forming tool KD2 for a thick plate is used in processing the thick plate workpiece Wb.

### Configuration of Protruded Portion Forming Tool KD1 for Thin Plate

First, the protruded portion forming tool KD1 for a thin plate will be described with reference to FIGS. 1A and 1B. FIG. 1A is a schematic cross-sectional view showing a configuration example of the protruded portion forming tool KD1 for a thin plate to form an alignment protruded portion WcA according to a first embodiment. FIG. 1B is an enlarged view of a part of FIG. 1A.

The protruded portion forming tool KD1 for a thin plate is used in forming the alignment protruded portion WcA in the workpiece Wa with a plate thickness of less than 1.6 mm classified for a thin plate. The protruded portion forming tool KD1 for a thin plate comprises a punch 11, and a die 12 including a counter 13. The punch 11 and the die 12 are attached to a turret punch press (not shown) or the like in such a positional relation: in which they are coaxially disposed to be opposite to each other. When forming the alignment protruded portion WcA, the punch 11 is moved (lowered) toward the die 12 by an operation of the turret punch press, and sandwiches and presses the workpiece Wa in cooperation with the counter 13 that is a die-side member disposed at an opposite position.

In the workpiece Wa, a rectangular lower hole Wa1 (see FIG. 1B) corresponding to the punch 11 is formed in advance in a separate step. The punch 11 is aligned in a horizontal direction so that only a right edge of the punch contacts with the lower hole Wa1 during processing. In FIG. 1B, the shape of the lower hole Wa1 before processed with the punch 11 is indicated with a dotted chain line. A portion of the workpiece Wa that is to be contacted with the punch 11 is referred to as a protruded portion forming material remained portion Rm. Hereafter, the protruded portion forming material remained portion is also referred to as a projection Rm.

The punch 11 is formed in a rectangular prism shape with its axis extending vertically. The punch 11 includes, at its lower edge, a chamfered edge C processed for chamfering with a C plane at a chamfered angle θc (see FIG. 1B). The chamfered edge C may be provided only at a right edge in the lower end of the punch 11.

The die 12 has a flat upper surface that abuts on the workpiece Wa, and a through hole is formed in a range corresponding to the punch 11, and the counter 13 is received to rise and lower within the through hole. The counter 13 is urged upward by a spring (not shown). The counter 13 lowers by a predetermined movement amount o by receiving a downward pressing force of the punch 11 against this urging force.

In the processing of the alignment protruded portion WcA, the punch 11 is lowered to pass through the lower hole Wa1 and abuts on an upper surface 13a of the counter 13. When the punch 11 is further lowered to reach a lower end position of a lowering range, the counter 13 moves down by a predetermined movement amount 8. Currently, the protruded portion forming material remained portion Rm of the workpiece Wa plastically flows into a space extending in a front-rear direction (page space front-back direction in FIG. 1B) between a chamfered edge C and the upper surface 13a of the counter 13 as the punch 11 moves down. Consequently, the protruded portion forming material remained portion Rm turns to the alignment protruded portion WcA extending from the right edge of the lower hole Wa1 to the lower left, as shown in FIG. 1B.

The shape of the alignment protruded portion WcA generally follows the shape of the chamfered edge C. That is, the alignment protruded portion WcA is formed as a region that extends in a front-rear direction corresponding to the width of the punch 11 in the front-rear direction at the right edge of the lower hole Wa1 and extends to the lower left.

Specifically, the alignment protruded portion WcA has a bottom face X and an inclined face XC in a cross-sectional shape in FIG. 1B. The bottom face X is a surface formed in contact with the upper surface 13a of counter 13, and the inclined face XC is an inclined face formed when rolled on the sloped face of the chamfered edge C. Therefore, the protrusion angle θw, which is the angle formed by the bottom face X and the inclined face XC, is the same angle as the chamfered angle θc of the chamfered edge C. The alignment protruded portion WcA extends diagonally from an end portion Wcs that is a lower end of the right edge of the lower hole Wa1 of the workpiece Wa towards the lower left, and is formed to be long in the front-rear direction. The chamfered angle θc is, for example, 30°.

The vertical length (height Wct) of the alignment protruded portion WcA is determined by a predetermined movement amount δ of the counter 13. Specifically, the maximum value of the height Wct indicates the movement amount δ. Therefore, the height Wct of the alignment protruded portion WcA can be set to a different height depending on the predetermined movement amount δ of the counter 13. For example, when the predetermined movement amount δ is 0.5 mm, the alignment protruded portion WcA is formed to set the height Wct to a maximum of 0.5 mm from the end portion Wcs below the workpiece Wa.

### Configuration of Protruded Portion Forming Tool KD2 for Thick Plate

Next, the protruded portion forming tool KD2 for a thick plate will be described with reference to FIGS. 2A and 2B. FIG. 2A is a schematic cross-sectional view showing a configuration example of the protruded portion forming tool KD2 for a thick plate to form an alignment protruded portion WcB according to one aspect of the present embodiment. FIG. 2B is an enlarged view of a part of FIG. 2A. With reference to FIGS. 2A and 2B, a configuration example of the protruded portion forming tool KD2 for a thick plate will be described.

The protruded portion forming tool KD2 for a thick plate is used in forming the alignment protruded portion WcB on a workpiece Wb with a plate thickness of 1.6 mm or more classified for a thick plate. The protruded portion forming tool KD2 for a thick plate is different in configuration of a die 22 from the protruded portion forming tool KD1 for a thin plate.

The protruded portion forming tool KD2 for a thick plate includes a punch 21 and the die 22. The punch 21 has the same shape as the punch 11 of the protruded portion forming tool KD1 for a thin plate. In contrast, the die 22 does not include a member corresponding to the counter 13 and has a flat upper surface 22a on which the punch 21 abuts when the punch moves down.

The workpiece Wb supplied to the protruded portion forming tool KD2 for a thick plate is different only in plate thickness from the workpiece Wa supplied to the protruded portion forming tool KD1 for a thin plate, and a similar lower hole Wb1 is formed in a separate step in advance. When forming an alignment protruded portion WcB, the punch 21 is moved (lowered) toward the die 22 by the operation of a turret punch press (not shown), to sandwich and press the workpiece Wb between the punch and the upper surface 22a of the die 22. The punch 21 is aligned in the horizontal direction with respect to the lower hole Wb1 so that the punch contacts only with a right edge in FIG. 2B for processing. In FIG. 2B, the shape of the lower hole Wb1 before processing with the punch 21 is indicated with a dotted chain line. A portion in the workpiece Wb that is to be contacted with the punch 21 is referred to as protruded portion forming material remained portion Rm. Hereafter, the protruded portion forming material remained portion Rm is also referred to as a projection Rm.

Similarly to the punch 11, the punch 21 is formed in a rectangular prism shape with its axis extending vertically. The punch 21 includes, at a lower end, a chamfered edge C processed for chamfering with a C plane at a chamfered angle θc (see FIG. 2B). The chamfered edge C may be provided only at a right edge in the lower end of the punch 21.

In the processing of the alignment protruded portion WcB, the punch 21 is lowered to pass through the lower hole Wb1, and abuts on the upper surface 22a of the die 22 to stop. Currently, the workpiece Wb is sandwiched and pressed between the punch 21 and the die 22. Currently, the protruded portion forming material remained portion Rm of the workpiece Wb plastically flows into a space extending in the front-rear direction between the chamfered edge C and the upper surface 22a of the die 22 as the punch 21 moves down. As a result, the protruded portion forming material remained portion Rm turns to the alignment protruded portion WcB extending from a right edge of the lower hole Wb1 to the left, as shown in FIG. 2B.

The shape of the alignment protruded portion WcB generally follows the shape of the chamfered edge C. That is, the alignment protruded portion WcB is formed as a region that extends in the front-rear direction corresponding to the width of the punch 21 in the front-rear direction at the right edge of the lower hole Wb1 and extends out to the left.

Specifically, the alignment protruded portion WcB has a bottom face X and an inclined face XC in a cross-sectional shape in FIG. 2B. The alignment protruded portion WcB has a protruded shape with a triangular cross section formed by the bottom face X in contact with the die 22 to form an extension surface from the lower surface of the workpiece Wb, and the inclined face XC including the sloped face of the chamfered edge C. A protrusion angle θw formed by the bottom face X and the inclined face XC is equal to the chamfered angle θc.

A reason for separately using the protruded portion forming tool KD1 for a thin plate and the protruded portion forming tool KD2 for a thick plate as described above lies in a plastic deformation amount when forming the alignment protruded portion Wc. The larger a plate thickness t of a workpiece W is, the larger the plastic deformation amount of the protruded portion forming material remained portion Rm when forming the alignment protruded portion Wc becomes. Therefore, when the workpiece W is the workpiece Wb of the thick plate and is formed in a shape like the alignment protruded portion WcA extending diagonally downward by the protruded portion forming tool KD1 for a thin plate, there is a higher possibility that defects such as cracks or wrinkles occur. Thus, in the thick plate workpiece Wb, to reliably form the alignment protruded portion Wc while reducing the plastic deformation amount, the alignment protruded portion WcB is formed to extend in a direction along an extending direction of the workpiece Wb, without allowing the alignment protruded portion Wc to extend diagonally so as to protrude outward from the surface.

### Method for Forming the Alignment Protruded Portion Wc for the First Workpiece W1

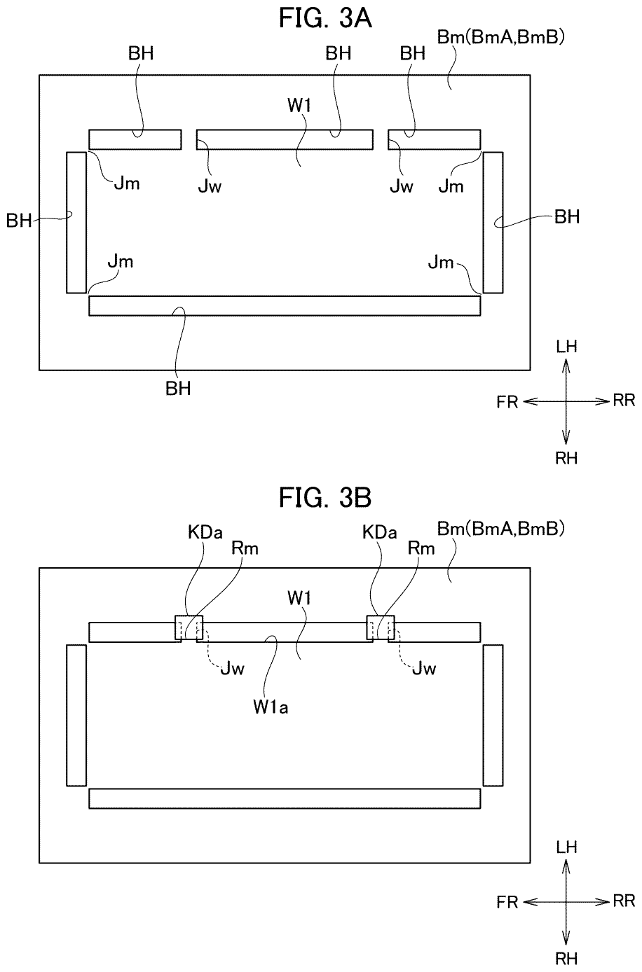

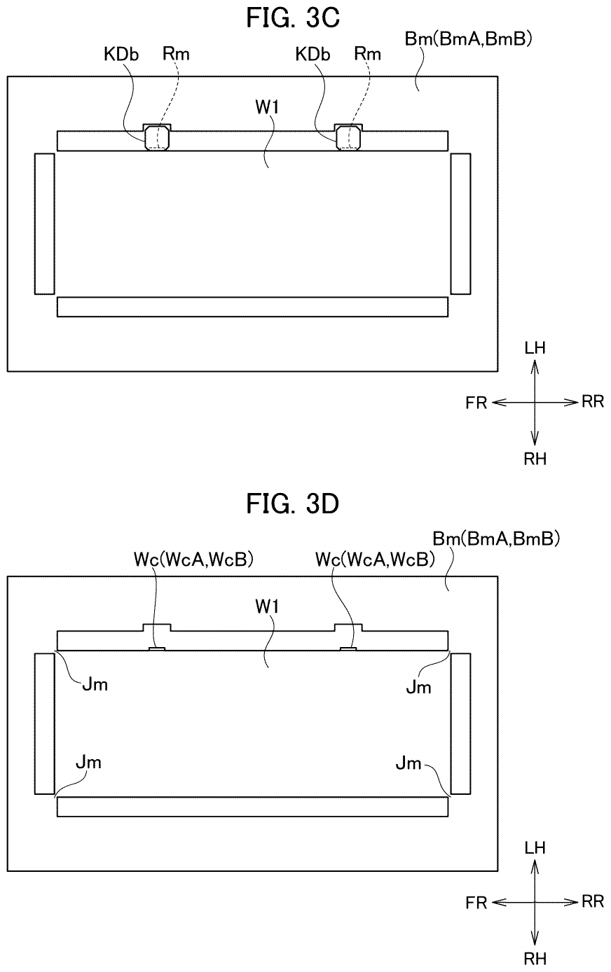

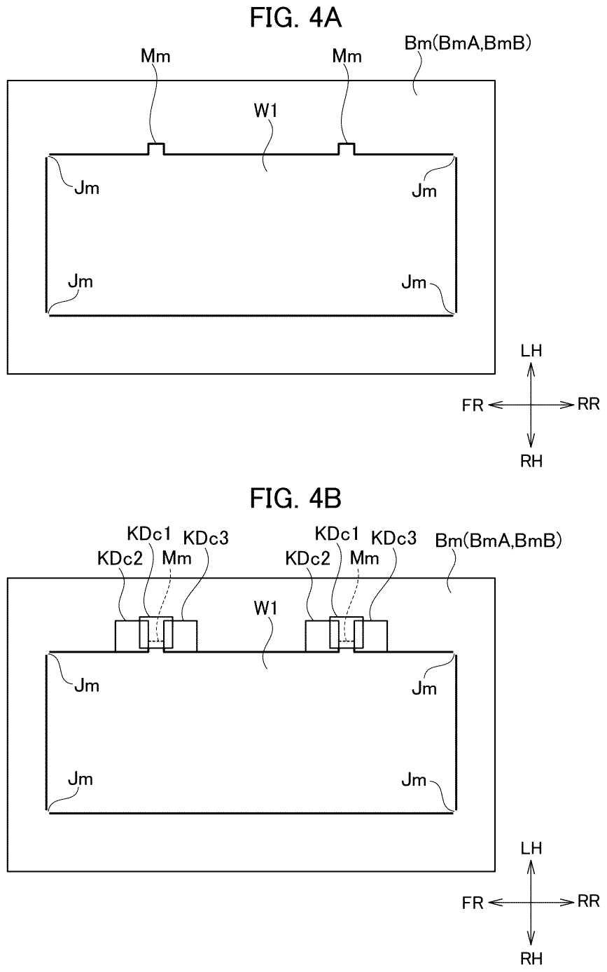

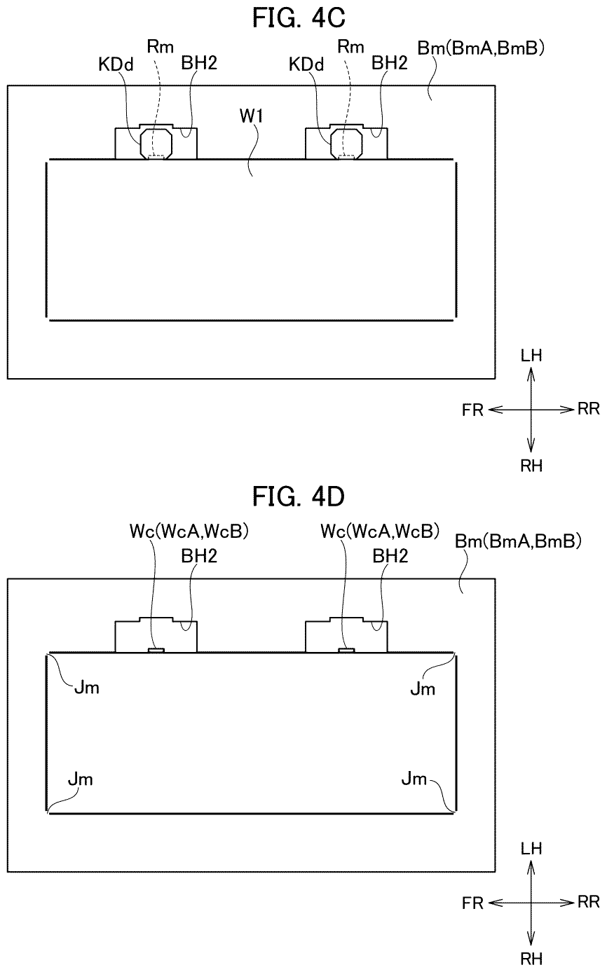

Next, described will be a method for forming the alignment protruded portion Wc on a first workpiece W1 that is one of two workpieces to be butt-welded after selecting either the protruded portion forming tool KD1 for a thin plate or the protruded portion forming tool KD2 for a thick plate depending on the plate thickness. The description refers to FIGS. 3A to 4D.

FIG. 3A is a first schematic plan view for describing a first embodiment in a method for forming the alignment protruded portion Wc. FIG. 3B is a second schematic plan view for describing the first embodiment. FIG. 3C is a third schematic plan view for describing the first embodiment. FIG. 3D is a fourth schematic plan view for describing the first embodiment. FIG. 4A is a first schematic plan view for describing a second embodiment in the method for forming the alignment protruded portion Wc. FIG. 4B is a second schematic plan view for describing the second embodiment. FIG. 4C is a third schematic plan view for describing the second embodiment. FIG. 4D is a fourth schematic plan view for describing the second embodiment.

The first workpiece W1 is cut out from a base material Bm that is a metal plate. The base material Bm is a steel plate, and if necessary, the base material Bm is distinguished with signs for a thin plate base material BmA and a thick plate base material BmB. Also, the alignment protruded portions WcA and WcB are collectively referred to as the alignment protruded portion Wc when no distinction is necessary.

### First Embodiment

The first embodiment is a method for punching out an outer shape (outline) of the first workpiece W1 with standard punching die. First, as shown in FIG. 3A, multiple rectangular openings BH are formed, with the standard punching die, along the outline of the first workpiece W1 laid out on the base material Bm. Four corners in the first workpiece W1 form micro joints Jm, which are micro connecting portions, to couple the first workpiece W1 and an offcut portion. Also, regions in which the alignment protruded portions WcA and WcB are formed (two locations) couple the first workpiece W1 and the offcut portion, as wire joints Jw, which are wider than the micro joints Jm, without forming the openings BH.

Next, as shown in FIG. 3B, each wire joint Jw is punched out with a rectangular standard punching die so that an edge portion of the first workpiece W1 is remained to slightly protrude. In FIG. 3B, a punching shape KDa of the standard punching die is shown with a solid line. The edge portion that remains and protrudes from the outline corresponds to the protruded portion forming material remained portion Rm. The protruded portion forming material remained portion Rm projects from an entire height of an end face W1a of the first workpiece W1.

Next, as shown in FIG. 3C, using the protruded portion forming tool KD1 for a thin plate or the protruded portion forming tool KD2 for a thick plate, forming processing is performed including plastically deforming the protruded portion forming material remained portions Rm as previously described to form the alignment protruded portions WcA and WcB. In FIG. 3C, a punching shape KDb of a punching tool is shown with a solid line. In the base material BmA, the alignment protruded portion WcA is formed using the protruded portion forming tool KD1 for a thin plate, and in the base material BmB, the alignment protruded portion WcB is formed using the protruded portion forming tool KD2 for a thick plate. The alignment protruded portions WcA and WcB are formed by plastically deforming the projections Rm (the protruded portion forming material remained portions Rm) projecting from the entire height of the end face W1a of the first workpiece W1 through a punching downward motion of the punches 11 and 21 in a thickness direction, so that they protrude from a partial height of the end face W1a (its lower portion).

This forming processing results in the formation of the alignment protruded portion Wc (WcA, WcB) shown in FIG. 3D. Thereafter, the micro joints Jm are cut off by a known method, to obtain the first workpiece W1 including the alignment protruded portions Wc.

### Second Embodiment

The first workpiece W1 is not limited to the method of punching with the standard punching die described above (first embodiment) and may be cut from the base material Bm by a method of cutting with a laser beam as described below (second embodiment).

As shown in FIG. 4A, the outline of the first workpiece W1 is cut with a laser beam, leaving four corners as micro joints Jm that are micro connecting portions. Here, the outline is cut to form projections Mm that protrude rectangularly to the left in regions (two locations) to form alignment protruded portions Wc.

Next, as shown in FIG. 4B, with a rectangular standard punching die, each projection Mm is left and formed to slightly protrude from the outline of the first workpiece W1. This punching shape KDc1 is shown with a solid line. The portion that is left by this forming to protrude from the outline turns to the protruded portion forming material remained portion Rm (projection Rm). Furthermore, adjacent front and rear portions are also punched to partially overlap the punching shape KDc1. Respective punching shapes KDc2 and KDc3 are shown with solid lines. By this punching, one opening BH2 is formed as shown in FIG. 4C.

Next, to plastically deform the protruded portion forming material remained portion Rm, the protruded portion forming tool KD1 for a thin plate is used for a base material BmA, and the protruded portion forming tool KD2 for a thick plate is used for a base material BmB to perform forming processing. In FIG. 4C, this punch shape KDd is shown with a solid line.

Consequently, an alignment protruded portion Wc shown in FIG. 4D is formed. Specifically, as described with reference to FIGS. 1B and 2B, an alignment protruded portion WcA is formed with the protruded portion forming tool KD1 for a thin plate in the base material BmA, and an alignment protruded portion WcB is formed with the protruded portion forming tool KD2 for a thick plate in the base material BmB. Thereafter, micro joints Jm are cut off by a known method, to obtain the first workpiece W1 including the alignment protruded portion Wc.

### Operations and Effects

As described above, according to one aspect of the method for forming the alignment protruded portion Wc, in a first step, the outline of the first workpiece W1 is cut out to form, in four corners, the micro joints Jm that are connecting portions connecting to the base material Bm. Therefore, during a work of cutting out the first workpiece W1 from the base material Bm, the first workpiece W1 is maintained in a state of being coupled to the base material Bm. Consequently, the alignment protruded portion Wc can be formed at a predetermined position on the outline of the first workpiece W1 while the base material Bm is held. This can stably obtain the alignment protruded portion Wc with highly precise shape and dimension.

In addition, in the step of forming the alignment protruded portion Wc, a projection Rm is formed in advance at a position at which the alignment protruded portion Wc is to be formed. This can secure a sufficient volume of material for plastically deforming and forming the alignment protruded portion Wc through subsequent forming processing.

Specifically, a second step includes performing forming processing by the punches 11 and 21 contacting with the projections Rm and Mm to plastically deform them. This forming processing allows the projection Rm to plastically flow and form the alignment protruded portion Wc extending outward from the end face of the first workpiece W1. The alignment protruded portion Wc has a lateral cross-sectional shape that is a tapered shape (substantially triangular shape) including the inclined face XC and the bottom face X. The inclined face XC is formed to have a shape having a protrusion angle θw corresponding to a chamfered angle θc of the chamfered edge C of an end face of the punch 11 or 21. Furthermore, when the first workpiece W1 is a thin plate, it is possible to control the protruding amount (height Wct) of the alignment protruded portion Wc in the thickness direction of the first workpiece W1 by a downward movement amount δ of the punch 11 from the lower surface of the first workpiece W1 during a punch lowering stroke.

By controlling the protrusion angle θw and height Wct in the alignment protruded portion Wc, as will be described later, engagement of the alignment protruded portion Wc with the alignment depressed portion Wd formed on the surface of the second workpiece W2 can be achieved with high precision. This engagement allows for alignment of the first workpiece W1 and the second workpiece W2 with high precision without using a jig in a state where the workpieces abut to form right angles. The first workpiece W1 and the second workpiece W2 can apply the workpiece W. That is, the first workpiece W1 and the second workpiece W2 are metallic plates, such as steel plates or aluminum plates. The steel plate is, for example, a cold-rolled steel plate (SPC) or a stainless-steel plate (SUS). In addition, the second workpiece W2 does not have to be a plate material and may be a solid material such as iron or aluminum.

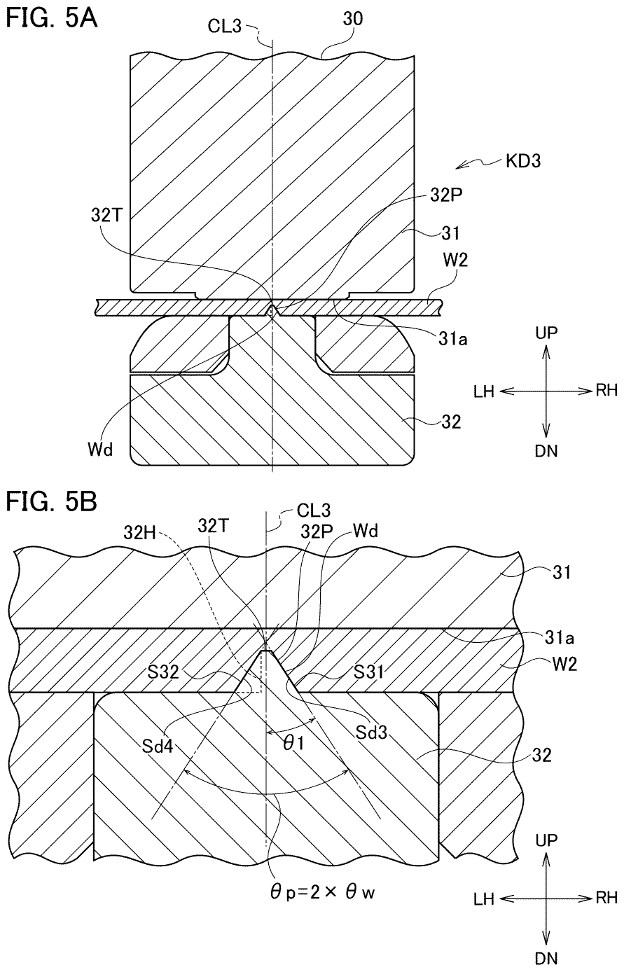

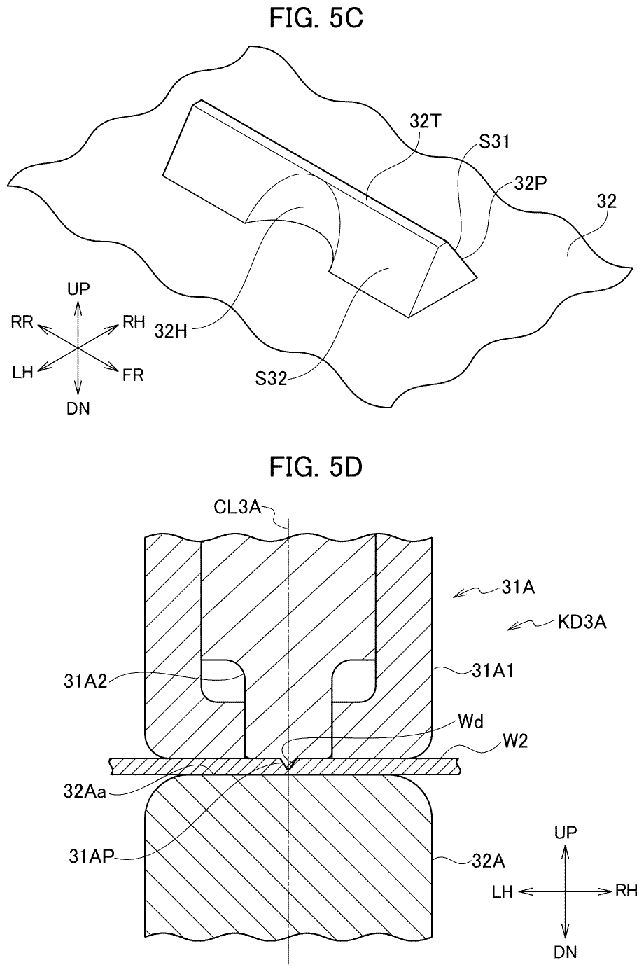

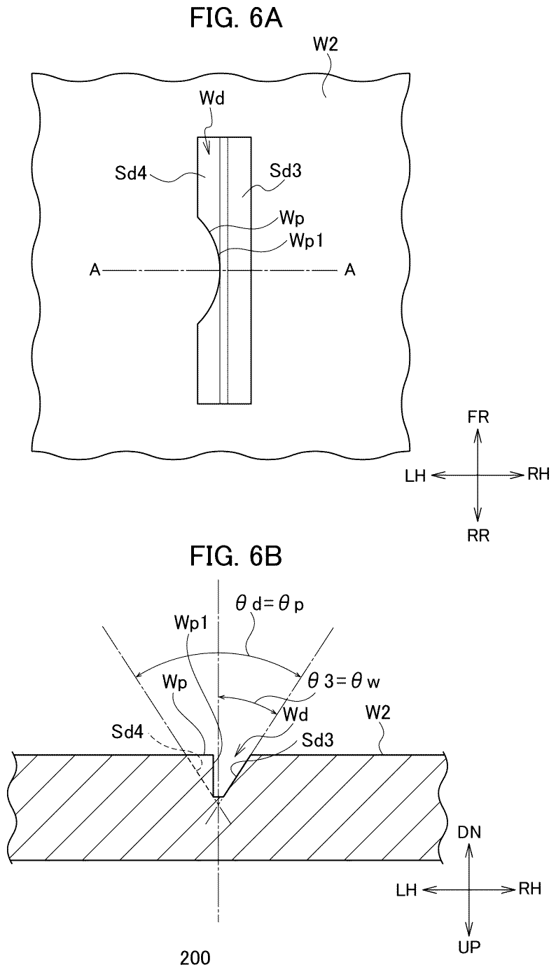

Next, an alignment depressed portion Wd (see FIG. 6A) in which the alignment protruded portion Wc engages, and a depressed portion forming tool KD3 for forming the alignment depressed portion Wd and a depressed portion forming tool KD3A according to a modification will be described with reference to FIGS. 5A to 5D.

FIG. 5A is a schematic cross-sectional view showing a configuration example of the depressed portion forming tool KD3 to form an alignment depressed portion Wd according to one aspect of the present embodiment. FIG. 5B is an enlarged view of a part of FIG. 5A. FIG. 5C is a perspective view of a forming portion 32P of the depressed portion forming tool KD3 seen from left front diagonally upward. FIG. 5D is a schematic cross-sectional view showing a configuration example of the depressed portion forming tool KD3A according to the modification of the depressed portion forming tool KD3.

### Configuration of Depressed Portion Forming Tool KD3

The alignment precision of the first workpiece W1 and the second workpiece W2, which are aligned by the engagement of the alignment protruded portion Wc and the alignment depressed portion Wd, improves as a gap between the alignment protruded portion Wc and the alignment depressed portion Wd in an engaged state decreases. Therefore, it is desirable that the shape and dimension of the alignment depressed portion Wd are the same shape and dimension as those of the alignment protruded portion Wc that has its depression/protrusion inverted.

In other words, in the tool, it is desirable that the forming portion to form the alignment depressed portion Wd has about the same shape and dimension as the alignment protruded portion Wc formed on the first workpiece W1.

In this desirable aspect, the forming portion of the tool has a length and linearly protrudes, forming a tapered shape at a protrusion angle θw. The protrusion angle θw is the same as the chamfered angle θc, and is, for example, an acute angle of about 30°. Thus, there is a high possibility that the tip of the forming portion has defects such as crack due to force applied during forming, and damage due to wear and abrasion. Therefore, the depressed portion forming tool KD3 can reduce occurrence of the defects at the tip and can form the alignment depressed portion Wd as a depressed portion capable of alignment with high precision.

As shown in FIG. 5A, the depressed portion forming tool KD3 comprises a punch 31 and a die 32. The punch 31 has, at its lower end, a flat surface portion 31a that contacts the second workpiece W2 with a flat plane. The die 32 includes a forming portion 32P as a portion to form the alignment depressed portion Wd. A portion of a tip end of the forming portion 32P is a tip portion 32T.

The punch 31 and the die 32 are attached to a turret punch press (not shown) or the like in such a positional relation to be opposed concentrically via an axis CL3. When forming the alignment depressed portion Wd, the punch 31 is moved (lowered) toward the die 32 by an operation of the turret punch press, and sandwiches and presses the second workpiece W2 in cooperation with the die 32 disposed at an opposite position.

As shown in FIG. 5B, the forming portion 32P has a triangular lateral cross-sectional shape that protrudes upward and is formed in a rib shape extending in the front-rear direction (page space front-back direction in FIG. 5B). An angle θp formed by the tip portion 32T is set to be larger than the protrusion angle θw of the alignment protruded portion Wc (see FIGS. 1B and 2B). Specifically, the angle θp is set as an angle distributed left and right at the protrusion angle θw around an axis CL3 extending in the vertical direction through the tip portion 32T. That is, the angle θp=(protrusion angle θw)×2.

Thus, the forming portion 32P is formed at a larger angle formed by the lateral cross-sectional shape of the tip portion 32T as compared to when the forming portion has substantially the same shape and dimension as the alignment protruded portion Wc. Therefore, defects such as cracks and damages are unlikely to occur in the tip portion 32T. As shown in FIGS. 5B and 5C, the forming portion 32P has sloped faces S31 and S32. The sloped face S31 forms one depressed-portion inclined face Sd3 of the alignment depressed portion Wd, while the sloped face S32 forms the other depressed-portion inclined face Sd4. The sloped face S31 is formed as an inclined face in contact with the inclined face XC of the alignment protruded portion Wc when the alignment protruded portion Wc engages in the alignment depressed portion Wd.

A dent portion 32H is formed on the sloped face S32 of the forming portion 32P. The dent portion 32H has a circumferential shape like as being formed by gouging the sloped face S32 by a cylinder with a n axis extending in the vertical direction from the left to the right. As the alignment depressed portion Wd with a V-shaped cross section is formed by the forming portion 32P, the material of the second workpiece W2 plastically flows into the dent portion 32H. Thus, a protrusion Wp (see FIGS. 6A and 6B) is formed on the sloped face S32. Therefore, the alignment depressed portion Wd is formed as a groove that forms an inclination angle θ3 equivalent to the protrusion angle θw at the most protruding position of the protrusion Wp, as shown in FIG. 6B. The circumferential face Wp1 of the protrusion Wp is a surface extending in the vertical direction.

The lateral cross section of a portion of the alignment depressed portion Wd in which the protrusion Wp is not formed is formed in a V-shape with opposite surfaces inclined. An angle Od of this V-shape is the same as the angle Op of the tip portion 32T of the depressed portion forming tool KD3. Consequently, when the alignment protruded portion Wc formed on the first workpiece W1 is engaged so that the inclined face XC closely adheres to the depressed-portion inclined face Sd3 of the alignment depressed portion Wd, the bottom face X of the alignment protruded portion Wc becomes a surface extending in vertical and front-rear directions. That is, the bottom face X is in line contact with the most protruding region of the circumferential face Wp1 of the protrusion Wp.

Thus, when the alignment protruded portion Wc is engaged in the alignment depressed portion Wd, the inclined face XC of the alignment protruded portion Wc is in surface contact with and closely adheres to the depressed-portion inclined face Sd3 of the alignment depressed portion Wd, and the bottom face X of the alignment protruded portion Wc is in line contact with and closely adheres to the circumferential face Wp1 of the protrusion Wp of the alignment depressed portion Wd.

The inclined face XC, bottom face X, depressed-portion inclined face Sd3, and circumferential face Wp1 are all surfaces directly formed by the tool and are therefore formed stably and with high precision. Consequently, the alignment protruded portion Wc and the alignment depressed portion Wd are aligned with high precision in the horizontal direction in the engaged state. Furthermore, the engagement is a wedge-shaped engagement that tapers downward. Therefore, by engaging the first workpiece W1 with the second workpiece W2 from above, the alignment protruded portion Wc engages into the alignment depressed portion Wd due to the weight of the first workpiece W1. This maintains stable engagement of the first workpiece W1 with the second workpiece W2 without any slip.

Next, the schematic configuration of the depressed portion forming tool KD3A according to the modification of the depressed portion forming tool KD3 will be described with reference to FIG. 5D. The depressed portion forming tool KD3A is provided with a forming portion 31AP on a punch side, which was previously provided as the forming portion 32P on the die side in the depressed portion forming tool KD3.

As shown in FIG. 5D, the depressed portion forming tool KD3A comprises a punch 31A and a die 32A that are disposed opposite each other concentrically via an axis CL3A. The punch 31A includes a punch case 31A1 and a punch body 31A2.

The punch body 31A2 is moved up and down relative to the punch case 31A1 by an unillustrated drive unit. The punch body 31A2 includes the forming portion 31AP on its lower surface. The forming portion 31AP has the same shape as the forming portion 32P shown in FIGS. 5A to 5C, including a dent portion 32H, is formed on the punch side, and is therefore oriented in an inverted direction vertically.

On the other hand, an upper surface 32Aa of the die 32A is a flat surface portion.

When forming the depressed portion Wd, the punch case 31A1 of the punch 31A and the die 32A sandwich and hold the workpiece W2, and while lowering the punch body 31A2, the forming portion 31AP forms the depressed portion Wd on the surface of the workpiece W2 on the punch 31A side. This depressed portion Wd has the same shape as the depressed portion Wd formed with the depressed portion forming tool KD3.

### Method for Forming the Alignment Depressed Portion Wd

### (First Forming Method)

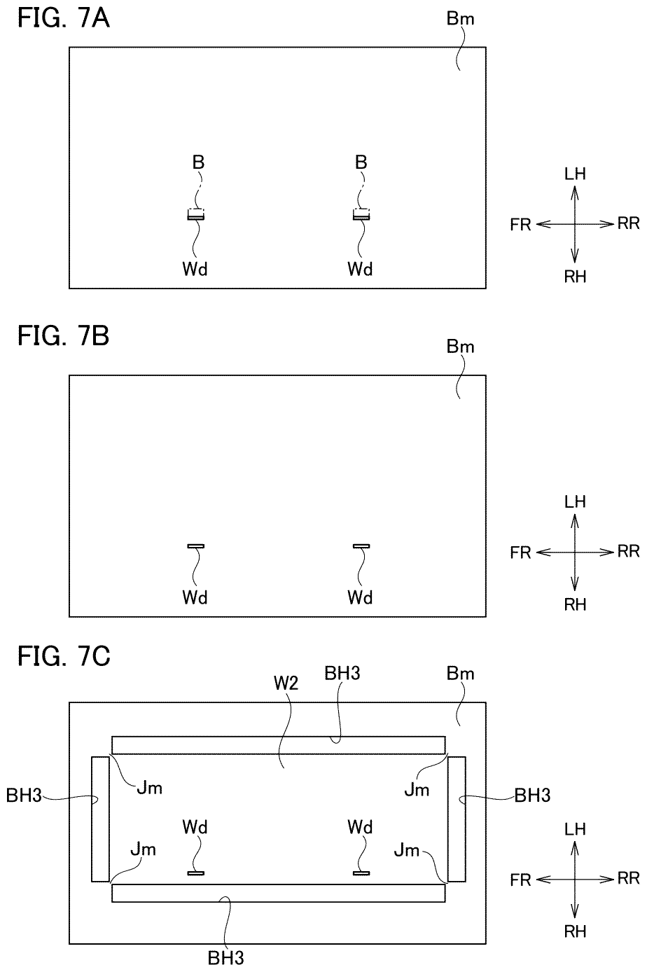

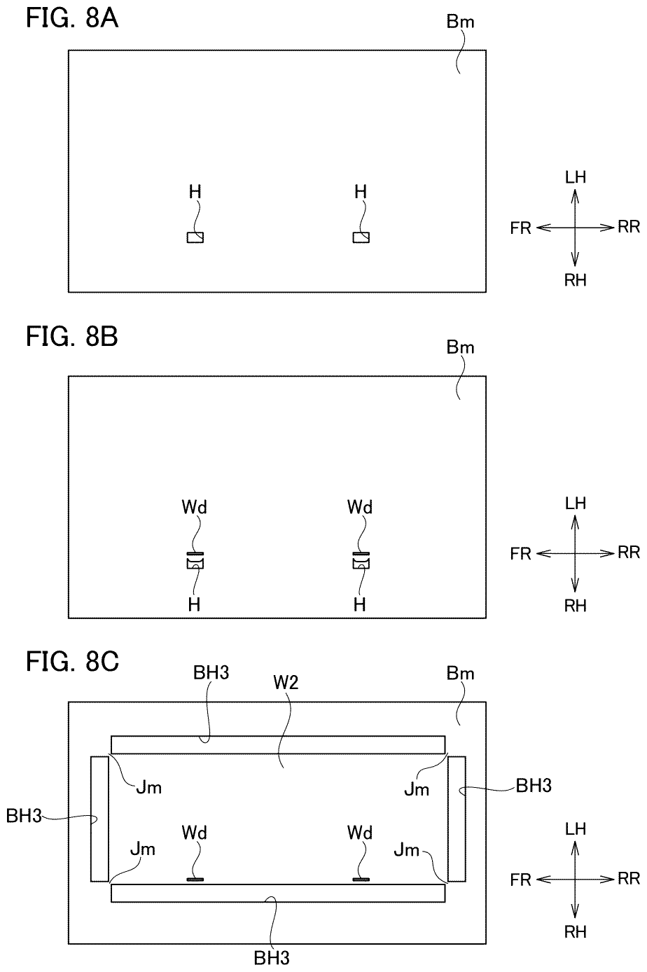

Next, an example of a method for forming the alignment depressed portion Wd for the second workpiece W2 will be described with reference to FIGS. 7A to 8C.

FIG. 7A is a schematic plan view showing a first step of a first forming method example of the alignment depressed portion Wd according to one aspect of the present embodiment. FIG. 7B is a schematic plan view showing a second step of the first forming method example of the alignment depressed portion Wd according to one aspect of the present embodiment. FIG. 7C is a schematic plan view showing a third step of the first forming method example of the alignment depressed portion Wd according to one aspect of the present embodiment. FIG. 8A is a schematic plan view showing a first step of a second forming method example of the alignment depressed portion Wd according to one aspect of the present embodiment. FIG. 8B is a schematic plan view showing a second step of the second forming method example of the alignment depressed portion Wd according to one aspect of the present embodiment. FIG. 8C is a schematic plan view showing a third step of the second forming method example of the alignment depressed portion Wd according to one aspect of the present embodiment.

First, with reference to FIGS. 7A to 7C, the first method for forming the alignment depressed portion according to one aspect of the present embodiment will be described.

### (First Forming Method)

FIG. 7A shows the first step. In the first step, imprint processing is performed on the base material Bm using the depressed portion forming tool KD3 to form a predetermined number of alignment depressed portions Wd at predetermined positions linearly spaced apart. Each alignment depressed portion Wd is to be formed such that the protrusion Wp is on the left side (upward in page space in FIG. 7A). Since processing in the first step is the imprint processing, a bulging portion B (dotted chain line) that bulges in the thickness direction is generated in a region adjacent to the alignment depressed portion Wd.

FIG. 7B shows the second step. In the second step, flattening processing is performed to flatten the bulging portion B generated in the first step. The bulging portion B is generated because a material of a dimpled portion of the alignment depressed portion Wd plastically flows to bulge in the thickness direction. In the second step, a general tool used for a flattening processing is used. By the flattening processing, the bulging portion B is substantially flattened as the material of a bulged portion plastically flows uniformly to peripheral members, and a height of bulging is reduced to a height that does not cause any trouble in practical use.

FIG. 7C shows the third step. In the third step, the second workpiece W2 is cut out from the base material Bm by punch processing with a standard punching die or cut processing with a laser beam. Currently, four corners of the second workpiece W2 form micro joints Jm as connecting portions connecting to the base material Bm. FIG. 7C shows an example where a outline is cut by forming openings BH3 to form the micro joints Jm with the standard punching die. The micro joints Jm are cut in a final stage of processing, separating the second workpiece W2 from the base material Bm. This obtains the second workpiece W2 with the alignment depressed portions Wd.

Next, with reference to FIGS. 8A to 8C, the second forming method for the alignment depressed portion Wd according to one aspect of the present embodiment will be described.

### (Second Forming Method)

FIGS. 8A to 8C are schematic views showing the second method for forming a depressed portion that engages with the alignment protruded portion according to one aspect of the present embodiment (from first to third steps). The first forming method is different in the first and second steps. Therefore, differences will only be described.

FIG. 8A shows the first step in the second forming method. In the first step, a hole H, which is a through hole, is formed at a position outside an outer peripheral portion (outline) of the second workpiece W2, the position corresponding to the formation position of the alignment depressed portion Wd. The hole H is formed as material relief so that a material corresponding to a depression when forming the alignment depressed portion Wd can easily flow plastically without affecting the thickness. The hole H is formed by punch processing with a standard punching die. Consequently, the material that loses its way due to the plastic flow generated when the alignment depressed portion Wd is formed can be released to deform the hole H. Therefore, the bulging portion B generated in the first forming method is not generated substantially.

FIG. 8B shows the second step. The second step is the same as the first step of the first forming method. FIG. 8C shows the third step. The third step is the same as the third step of the first forming method. As in the case of the first forming method, after the third step, the micro joint Jm is cut in the final stage, separating the second workpiece W2 from the base material Bm. This obtains the second workpiece W2 with the alignment depressed portion Wd. The hole H is formed in a member to be punched out when the outline is punched with the standard punching die, and remains in offcut in the case of laser cutting. Therefore, the hole H does not remain in the shape of the second workpiece W2.

As described above, according to the method for forming the alignment depressed portion of one aspect, the alignment depressed portion Wd with a V-shaped lateral cross section can be formed using the depressed portion forming tool KD3. The alignment depressed portion Wd includes one depressed-portion inclined face Sd3 on which the inclined face XC of the alignment protruded portion Wc abuts, and the other depressed-portion inclined face Sd4 formed including the protrusion Wp that contacts the bottom face X of the alignment protruded portion Wc.

Specifically, when the alignment depressed portion Wd engages with the alignment protruded portion, one depressed-portion inclined face Sd3 closely adheres to the inclined face XC of the alignment protruded portion Wc, and the protrusion Wp formed on the other depressed-portion inclined face Sd4 is in line contact with the bottom face X. Therefore, the alignment depressed portion Wd can substantially eliminate the gap generated when the alignment protruded portion Wc is engaged. Consequently, the first workpiece W1 and the second workpiece W2 can be aligned with high precision when abutted at right angles.

### Alignment Structure GK

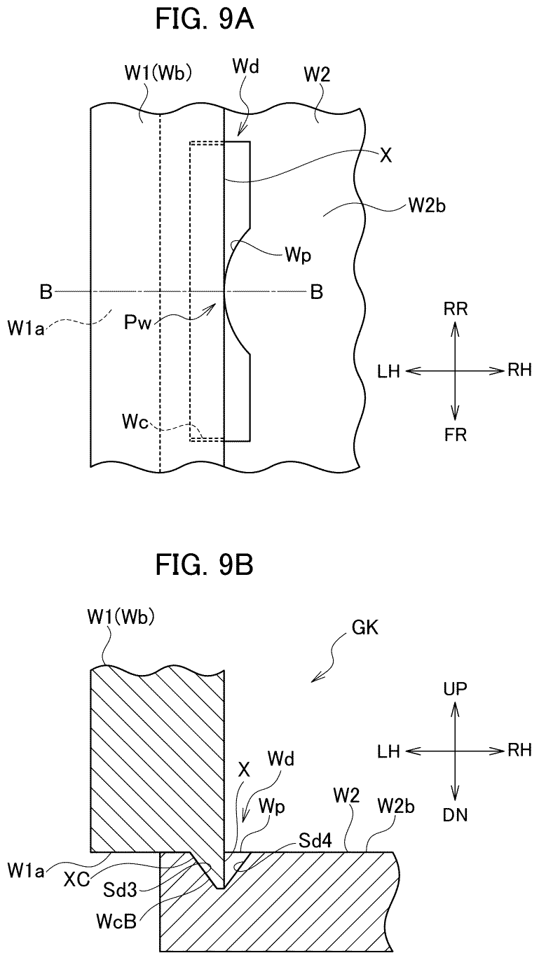

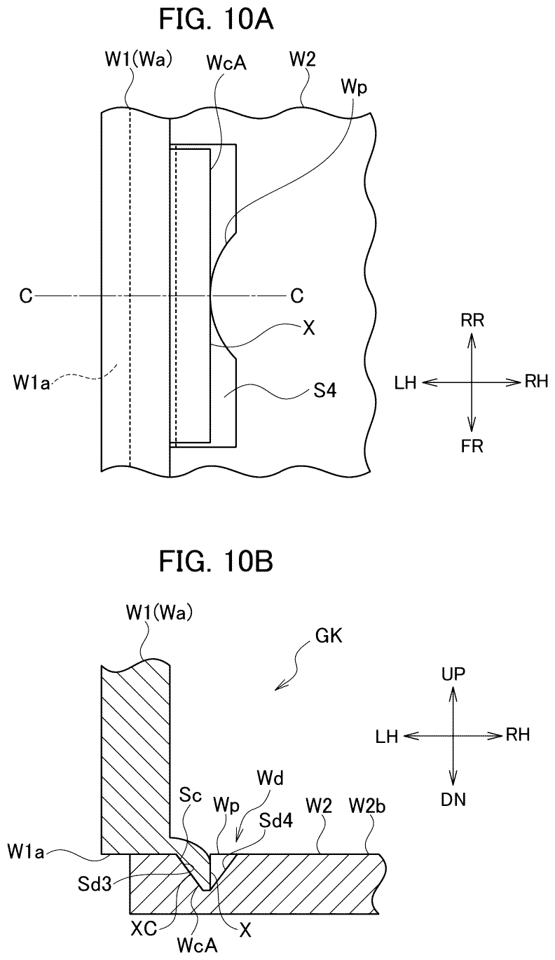

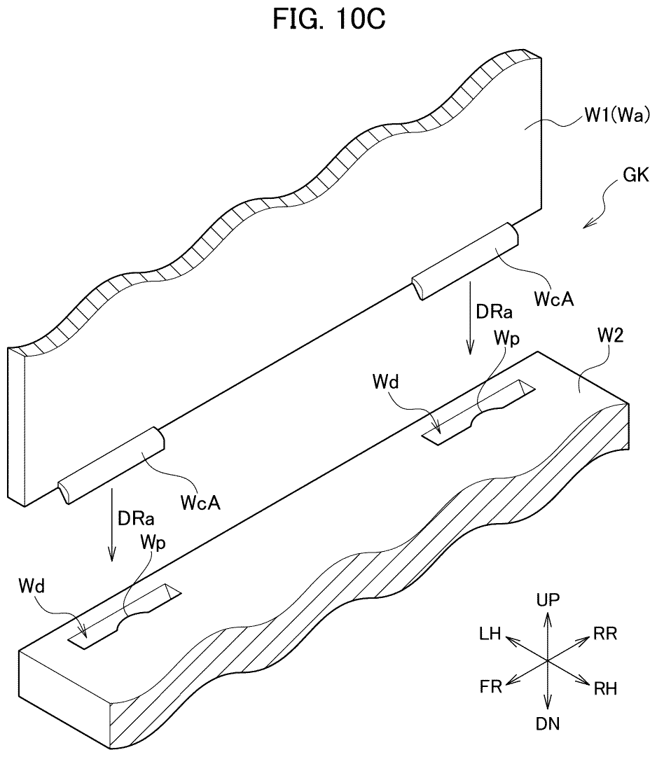

The alignment structure GK to align the first workpiece W1 and the second workpiece W2 by the engagement of the alignment protruded portion Wc and the alignment depressed portion Wd described above will be described with reference to FIGS. 9A to 10B, which show the state where the first workpiece W1 is orthogonally abutted on the second workpiece W2.

FIG. 9A is a top view for describing the alignment structure GK in a workpiece Wb of a thick plate. FIG. 9B is a cross-sectional view at position B-B of FIG. 9A. FIG. 10A is a top view for describing the alignment structure GK in a workpiece Wa of a thin plate. FIG. 10B is a cross-sectional view at position C-C of FIG. 10A. FIG. 10C is a perspective view for describing the alignment structure GK in the workpiece Wa of the thin plate.

The alignment structure GK in the thick plate workpiece Wb is an alignment structure when an end face W1a a first workpiece W1, which is the thick plate, is orthogonally abutted on a predetermined position in the vicinity of an end of a surface W2b (upper surface W2b) of a second workpiece W2, as shown in FIGS. 9A and 9B. The alignment structure GK in this thick plate includes an alignment protruded portion WcB formed on the first workpiece W1 and an alignment depressed portion Wd formed on the upper surface W2b of the second workpiece W2.

In the alignment depressed portion Wd, one depressed-portion inclined face Sd3 in an end portion in this example is formed at the same inclination angle as an inclination angle of an inclined face XC of the alignment protruded portion WcB, and the other depressed-portion inclined face Sd4 is formed to include a protrusion Wp having a circular circumferential face extending vertically in line contact with a bottom face X of the alignment protruded portion WcB at a position PW.

Consequently, when the alignment protruded portion WcB is engaged in the alignment depressed portion Wd, the alignment protruded portion WcB is entered into and engaged with the alignment depressed portion Wd, and the first workpiece W1 and the second workpiece W2 can be aligned in a butted state at right angles without using a jig. The first workpiece W1 in the horizontal direction abutted on the second workpiece W2 is aligned depending on the formation position of the alignment depressed portion Wd in the horizontal direction. FIG. 9B shows an abutment state with a so-called half-open corner joint where half of the end face W1a of the first workpiece W1 abuts on the second workpiece W2. In contrast, by forming the alignment depressed portion Wd further to the right in the second workpiece W2, it is possible to achieve an abutment state with a so-called closed corner joint where the entire surface of the end face W1a abuts on the second workpiece W2.

The alignment structure GK in the thin plate workpiece Wa is an alignment structure when the end face W1a of the first workpiece W1, which is the thin plate, is orthogonally abutted at a predetermined position in the vicinity of the end of the upper surface W2b of the second workpiece W2, as shown in FIGS. 10A to 10C. This alignment structure GK in the thin plate includes an alignment protruded portion WcA formed on the first workpiece W1 and an alignment depressed portion Wd formed on the upper surface W2b of the second workpiece W2.

Similarly to the case of the thick plate, in the alignment depressed portion Wd, one depressed-portion inclined face Sd3 in an end portion in this example is formed at the same inclination angle as an inclination angle of an inclined face XC of the alignment protruded portion WcA, and the other depressed-portion inclined face Sd4 is formed to include a protrusion Wp having a circular circumferential face extending vertically in line contact with a bottom face X of the alignment protruded portion WcB at the position Pw.

Consequently, as shown in FIG. 10C, when the alignment protruded portion WcA is engaged in the alignment depressed portion Wd, the alignment protruded portion WcA is entered into and engaged with the alignment depressed portion Wd, and the first workpiece W1 and the second workpiece W2 can be aligned in a butted state at right angles without using a jig. The first workpiece W1 abutted on the second workpiece W2 is aligned in the horizontal direction depending on the formation position of the alignment depressed portion Wd in the horizontal direction. FIG. 10B shows an abutment state with a half-open corner joint where half of the end face W1a of the first workpiece W1 in the thickness direction abuts on the second workpiece W2. In contrast, by forming the alignment depressed portion Wd further to the right in the second workpiece W2, it is possible to achieve a abutment state with a so-called closed corner joint where the entire surface of the end face W1a abuts on the second workpiece W2.

Furthermore, since the alignment protruded portion WcA of the thin plate first workpiece W1 is formed to protrude to the right from the surface as shown in FIG. 10B, the abutment position of the first workpiece W1 can be located further to the left compared to the case of the thick plate.

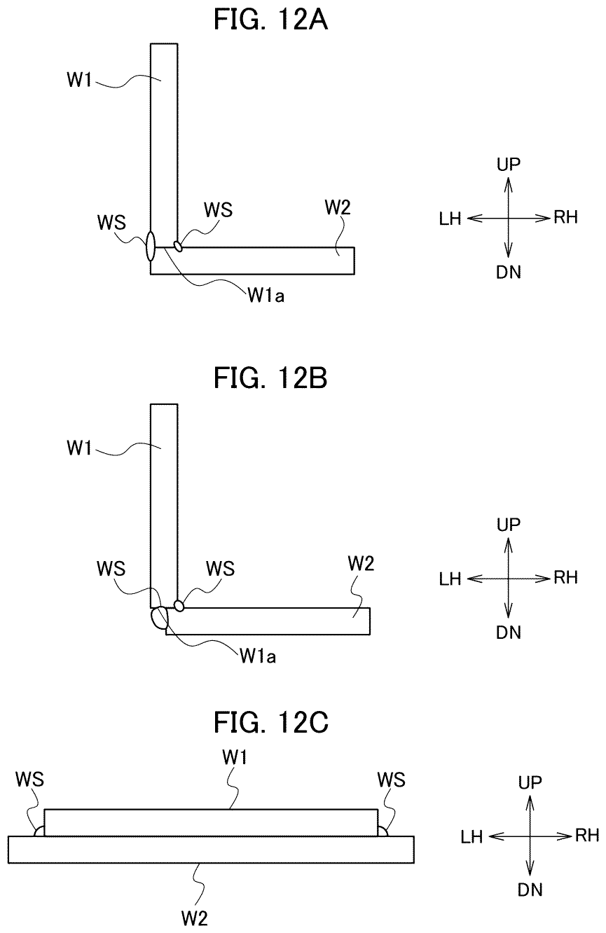

The alignment structure GK in the thin plate workpiece Wa is different from the alignment structure GK in the thick plate workpiece Wb in the position, in the thickness direction, at which the alignment protruded portion Wc is formed in the first workpiece W1. Specifically, the alignment protruded portion Wc (WcB) for a thick plate is formed to extend from the end face within a range of the thickness of the first workpiece W1. On the other hand, the alignment protruded portion Wc (WcA) for the thin plate is formed to extend from the end face beyond the range of the thickness of the first workpiece W1 and protrude from the surface in the thickness direction. Therefore, the alignment structure GK for the thin plate workpiece Wa can be adopted in an alignment method shown in FIGS. 12A and 12B, which will be described next. The alignment structure GK for the thin plate workpiece Wa can align the first workpiece W1 for abutment on the second workpiece W2 in a desired positional relation without using a jig, similarly to the Case of the thick plate.

### Alignment Structure GK2

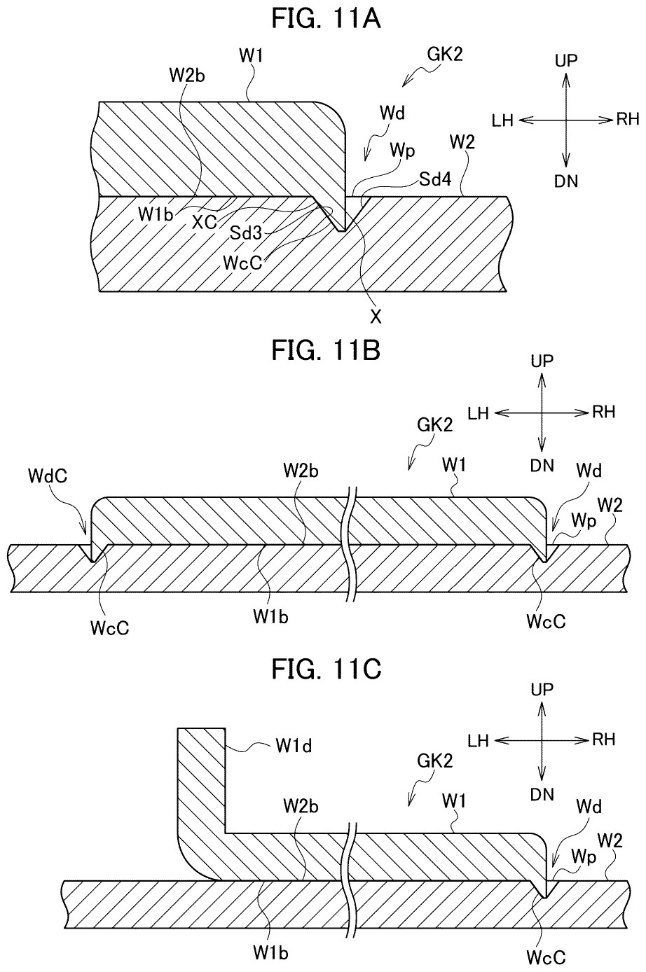

Using the alignment depressed portion Wd, the first workpiece W1, including a protruded portion for engagement in the alignment depressed portion Wd, can be stacked on and aligned with respect to the second workpiece W2. This stacking alignment structure is referred to as an alignment structure GK2, and will be described with reference to FIGS. 11A to 11C.

FIG. 11A is a partial cross-sectional view for describing the alignment structure GK2. FIG. 11B is a cross-sectional view for describing a first aspect of the alignment structure GK2. FIG. 11C is a cross-sectional view for describing a second aspect of the alignment structure GK2.

As shown in FIG. 11A, in the second workpiece W2, an alignment depressed portion Wd including a protrusion Wp is formed. This alignment depressed portion Wd is the same as the alignment depressed portion Wd in the alignment structure GK.

On the other hand, in the first workpiece W1, an alignment protruded portion WcC that engages in the alignment depressed portion Wd is formed. The alignment protruded portion WcC protrudes from the right edge portion of the first workpiece W1 in the thickness direction (downward) and is formed to be long in the front-rear direction (page space front-back direction).

For example, the alignment protruded portion WcC is formed by a method of filling burrs generated during punch processing of the right edge of the first workpiece W1 into a cavity of a tool having a predetermined shape through plastic flow. The alignment protruded portion WcC has a lateral cross section formed in a triangular shape tapered downward to an apex, and has a bottom face X extending in the thickness direction of the first workpiece W1, and an inclined face XC inclined to the bottom face X and extending at the same inclination angle as an inclination angle of a depressed-portion inclined face Sd3 of the alignment depressed portion Wd.

The first workpiece W1 is aligned with respect to the second workpiece W2 in a state where surfaces are stacked, rather than end faces, by engaging the alignment protruded portion WcC in the alignment depressed portion Wd from above. Specifically, the alignment protruded portion WcC is entered into the alignment depressed portion Wd, and a lower surface W1b of the first workpiece W1 and an upper surface W2b of the second workpiece W2 are stacked on one another in contact. In this case, the inclined face XC and the bottom face X of the alignment protruded portion WcC entered into the alignment depressed portion Wd contact the depressed-portion inclined face Sd3 of the alignment protruded portion Wd and a circumferential face Wp1 of a protrusion Wp extending in the thickness direction, respectively. Consequently, the first workpiece W1 is aligned with respect to the second workpiece W2 in the horizontal direction with high precision. The first workpiece W1 can be aligned in the front-rear direction with high precision because the alignment protruded portion WcC and the alignment depressed portion Wd are directly formed by tools, respectively, to minimize a gap in engagement in the front-rear direction.

FIG. 11b shows the first aspect of the alignment structure GK2. In the first workpiece W1, alignment protruded portions WcC are formed at opposite left and right ends, respectively, while in the second workpiece W2, an alignment depressed portion Wd with the protrusion Wp is formed as a depressed portion that engages with one of a pair of alignment protruded portions WcC formed on the first workpiece W1, and a depressed portion that engages with the other alignment protruded portion is formed as an alignment depressed portion WdC where the protrusion Wp is not formed.

In the first aspect, since the first workpiece W1 is in engagement with the second workpiece W2 at two locations at opposite left and right ends, rotation about axes in the horizontal direction as well as in the vertical direction is suitably regulated, so that stacking alignment is stabilized. Furthermore, since one of the two engagement locations is the alignment depressed portion Wd with the protrusion Wp, the first workpiece W1 can be aligned in the horizontal direction with high precision without using a jig.

FIG. 11C shows the second aspect of the alignment structure GK2. The first workpiece W1 is not just a flat plate but includes a bent portion W1d bent upward at the left edge, and has a three-dimensional shape where the alignment protruded portion cannot be formed. Even in this case, by using the alignment depressed portion Wd including the protrusion Wp in engagement at one edge (the right edge in FIG. 11C), the alignment in stacking the three-dimensional first workpiece W1 on the second workpiece W2 can be performed with high precision without using a jig.

### Welding Mode

Examples of a butt-welding mode possible with the alignment structure GK in the thick plate workpiece Wb or the alignment structure GK in the thin plate workpiece Wa will be described with reference to FIGS. 12A and 12B. FIG. 12A is a schematic side view showing a closed corner welding mode to which the alignment structure GK according to one aspect of the present embodiment can be applied. FIG. 12B is a schematic side view showing a half-open corner welding mode to which the alignment structure GK according to one aspect of the present embodiment can be applied.

FIG. 12A shows the closed corner welding mode. The alignment protruded portion WcA or WcB formed on the first workpiece W1 is engaged in the alignment depressed portion Wd formed on the second workpiece W2, and the first workpiece W1 and the second workpiece W2 are butted to form right angles. The formation position of the alignment depressed portion Wd in the horizontal direction is set in a closed corner joint where the entire surface of the end face W1a of the first workpiece W1 abuts on the upper surface W2b of the second workpiece W2.

Then, a butted portion between the first workpiece W1 and the second workpiece W2 is welded to form a welded portion WS. Thus, since the first workpiece W1 and the second workpiece W2 can be butt-welded in the closed corner joint without using a jig, the cost of the jig and the setting time of the jig can be reduced.

Depending on the formation position of the alignment depressed portion Wd in the horizontal direction, an abutment range of the end face W1a of the first workpiece W1 on the upper surface W2b of the second workpiece W2 can be varied. In the second workpiece W2, the alignment depressed portion Wd is formed at a position on the left side of that in FIG. 12A, and the so-called half-open corner butt-welding shown in FIG. 12B is accordingly possible.

As described above, the abutment position of the first workpiece W1 on the second workpiece W2 depends on the formation position of the alignment depressed portion Wd. That is, when the first workpiece W1 includes the alignment protruded portion WcA, the most protruding position that the bottom face X of the alignment protruded portion WcA contacts in the protrusion Wp of the alignment depressed portion Wd is to be set to a position obtained by adding the height Wct of the alignment protruded portion WcA to a position on the right side of a position on the surface (right surface in FIG. 10B) on which the alignment protruded portion WcA is formed in the first workpiece W1.

Also, when the first workpiece W1 includes the alignment protruded portion WcB, the most protruding position that the bottom face X of the alignment protruded portion WcB contacts in the protrusion Wp of the alignment depressed portion Wd is to be set to a position on the surface (right surface in FIG. 9B) on which the alignment protruded portion WcB is formed in the first workpiece W1. For the alignment protruded portion WcB, it can be considered that the height Wct of the alignment protruded portion WcB is 0 (zero). That is, the height Wct can be freely set between 0 (zero) and the movement amount δ at maximum.

The first workpiece W1 and the second workpiece W2 are in abutment engagement with a combination of a surface orthogonal to the thickness direction and an inclined face formed by the alignment protruded portion Wc and the alignment depressed portion Wd, which are directly formed by the tool in the thickness direction of the first workpiece W1 (the horizontal direction in FIGS. 9B and 10B), and are therefore aligned with high precision. Moreover, the alignment precision of the first workpiece W1 in the extending direction along the second workpiece W2 (the front-rear direction, that is, the page space front-back direction in FIGS. 9B and 10B) depends on a gap, in the front-rear direction, in the engagement state of the alignment protruded portion Wc and the alignment depressed portion Wd. This gap is generated based on a difference in length between the projection Rm and the depressed-portion inclined face Sd3 in the front-rear direction. However, since the projection Rm and the depressed-portion inclined face Sd3 are regions directly formed by the tool, a difference in length can be made small enough not to cause any trouble in practical use. Therefore, the alignment of the first workpiece W1 in the extending direction along the second workpiece W2 is performed with high precision. Also, the first workpiece W1 and the second workpiece W2 are aligned in the abutment direction (the vertical direction in FIGS. 9B and 10B) by the abutment between the end face and the surface and can therefore be aligned with sufficiently high precision. Thus, the first workpiece W1 and the second workpiece W2 are aligned with high precision in all three axial directions without using a jig, through the engagement of the alignment protruded portion Wc and the alignment depressed portion Wd.

FIG. 12C shows an example of the welding mode in the alignment structure GK2. FIG. 12C is a schematic cross-sectional view showing the example of the welding mode in the alignment structure GK2. The edge portion of the first workpiece W1, aligned with respect to the second workpiece W2 so that the surfaces overlap by the alignment structure GK2 for stacking, is welded by forming a welding portion WS by fillet welding. Thus, since the first workpiece W1 and the second workpiece W2 can be welded in a stacked manner without using a jig, the cost of the jig and the setting time of the jig can be reduced.

As described above in detail, the first aspect of the present invention is a tool KD3 comprising: a punch 31; and a die 32 disposed to be opposite to the punch 31 in a vertical direction, wherein one of the punch 31 and the die 32 has a flat surface portion 31a on a surface facing another thereof, wherein the other has a rib-shaped forming portion 32P that extends long in one direction and protrudes toward the one to have a triangular cross-sectional shape, and wherein a dent portion 32H is formed on one S32 of sloped faces of the forming portion 32P so as to be gouged to form a circumferential face of a cylinder with a vertical axis.

By forming a depressed portion in the second workpiece W2 using this tool, the first workpiece W1 can be aligned with respect to the second workpiece W2 without using a jig, so that the cost of the jig and the setting time of the jig in an alignment work can be reduced.

In addition, the second aspect of the present invention is a method for forming an alignment depressed portion, by using a tool KD3 that includes a die 32 disposed to be opposite to a punch 31 in a vertical direction, wherein one of the punch 31 and the die 32 has a flat surface portion 31a on a surface facing another thereof, wherein the other has a rib-shaped forming portion 32P that extends long in one direction and protrudes toward the one to have a triangular cross-sectional shape, and wherein a dent portion 32H is formed on one S32 of sloped faces of the forming portion 32P so as to be gouged to form a circumferential face of a cylinder with a vertical axis, the method comprising: by pressing a metal plate (second workpiece) W2 between the punch 31 and the die 32, forming an alignment depressed portion Wd on the metal plate W2, the alignment depressed portion Wd having a V-shaped cross-section that corresponds to the triangular cross-sectional shape of the forming portion 32P and a protrusion Wp protruding to have a circumferential face Wp1 that extends in the vertical direction and is associated with the dent portion 32H.

Since the first workpiece W1 can be aligned with respect to the second workpiece W2 by the alignment depressed portion formed in this manner without using a jig, the cost of the jig and the setting time of the jig in the alignment work can be reduced.

The third aspect of the present invention is an alignment structure GK comprising: an alignment protruded portion Wc formed to be protruded from an end face W1a of a first workpiece W1 that is a metal plate; and an alignment depressed portion Wd formed on a surface W2b of a second workpiece W2 such that the alignment protruded portion Wc is entered thereinto and engaged therewith, wherein the alignment protruded portion Wc is formed to have a tapered shape that has a bottom face X extending in an expanding direction of the first workpiece Wd and an inclined face XC inclined with respect to the bottom face X, wherein the alignment depressed portion Wd is a depressed portion that extends in one direction to have a given length and whose cross-sectional shape is formed to have a V-shape including a pair of depressed-portion inclined faces Sd3, Sd4 inclined with respect to a thickness direction of the second workpiece W2, a protrusion Wp that has a face extending in the thickness direction being formed in the middle of the length, and wherein the first workpiece W1 is aligned in an orthogonal manner with respect to the second workpiece W2, while engaging the alignment depressed portion Wd is engaged with the alignment protruded portion Wc, due to an alignment in which the inclined face XC of the alignment protruded portion Wc contacts one of the pair of depressed-portion inclined faces Sd3, Sd4 and the bottom face X thereof contacts the face of the protrusion Wp extending in the thickness direction.

Consequently, since the first workpiece W1 can be aligned with respect to the second workpiece W2 without using a jig, the cost of the jig and the setting time of the jig in the alignment work can be reduced.

The fourth aspect of the present invention is an alignment structure GK2 comprising: an alignment protruded portion WcC formed to be protruded from an edge portion W1a of a first workpiece W1 that is a metal plate; and an alignment depressed portion Wd formed on a surface W2d of a second workpiece W2 such that the alignment protruded portion WcC is entered thereinto and engaged therewith, wherein the alignment protruded portion WcC is formed to have a tapered shape that has a bottom face X extending in a thickness direction of the first workpiece W1 and an inclined face XC inclined with respect to the bottom face X, wherein the alignment depressed portion Wd is a depressed portion that extends in one direction to have a given length and whose cross-sectional shape is formed to have a V-shape including a pair of depressed-portion inclined faces Sd3, Sd4 inclined with respect to a thickness direction of the second workpiece W2, a protrusion Wp that has a face extending in the thickness direction thereof being formed in the middle of the length, and wherein the first workpiece W1 is aligned in a stacked manner with respect to the second workpiece W2, while engaging the alignment depressed portion Wd is engaged with the alignment protruded portion WcC, due to an alignment in which the inclined face XC of the alignment protruded portion WcC contacts one of the pair of depressed-portion inclined faces Sd3, Sd4 and the bottom face X thereof contacts the face of the protrusion Wp extending in the thickness direction.

Consequently, since the first workpiece W1 can be aligned with respect to the second workpiece W2 without using a jig, the cost of the jig and the setting time of the jig in the alignment work can be reduced.

The embodiments of the present invention are not limited to the above-mentioned configurations, and modifications may be provided without departing from the gist of the present invention.

The shape of the forming portion 32P is not limited to the above shape. The shape of the forming portion 32P may be such that at least one sloped face S31 closely adheres to the inclined face XC of the alignment protruded portion Wc. Furthermore, the surface shape of the dent portion 32H does not have to be cylindrical and may be a rectangular tubular shape. Additionally, the position where the dent portion 32H is provided may be any position in the forming portion 32P in the front-rear direction, and multiple dent portions may be provided independently.

The forming portion 32P may not include the dent portion 32H, and the inclination angle θ1 formed by the sloped face S31 to an orthogonal plane including the axis CL3 and the inclination angle formed by the sloped face S32 (angle θp-inclination angle θ1) may be different. The number of sets of the alignment protruded portion Wc and the alignment depressed portion Wd that engage between the first workpiece W1 and the second workpiece W2 is not limited to two sets as described above and may be one set. Moreover, if the end face that abuts is long, the number of sets may be three or more.

The disclosure of this application relates to the subject described in Japanese Patent Application No. 2022-202273 filed to Japan Patent Office on Dec. 19, 2022, the entire disclosure content of which is hereby incorporated by reference.

1. A tool comprising: a punch; and a die disposed to be opposite to the punch in a vertical direction,
wherein one of the punch and the die has a flat surface portion on a surface facing another of the punch and the die,
wherein the other has a rib-shaped forming portion that extends long in one direction and protrudes toward the one to have a triangular cross-sectional shape, and
wherein a dent portion is formed on one of sloped faces of the forming portion so as to be gouged to form a circumferential face of a cylinder with a vertical axis.

2. A method for forming an alignment depressed portion,
by using a tool that includes a punch; and a die disposed to be opposite to the punch in a vertical direction, wherein one of the punch and the die has a flat surface portion on a surface facing another of the punch and the die, wherein the other has a rib-shaped forming portion that extends long in one direction and protrudes toward the one to have a triangular cross-sectional shape, and wherein a dent portion is formed on one of sloped faces of the forming portion so as to be gouged to form a circumferential face of a cylinder with a vertical axis,
the method comprising:
by pressing a metal plate between the punch and the die,
forming an alignment depressed portion on the metal plate, the alignment depressed portion having a V-shaped cross-section that corresponds to the triangular cross-sectional shape of the forming portion and a protrusion protruding to have a circumferential face that extends in the vertical direction and is associated with the dent portion.

3. An alignment structure comprising:
an alignment protruded portion formed to be protruded from an end face of a first workpiece that is a metal plate; and
an alignment depressed portion formed on a surface of a second workpiece such that the alignment protruded portion is entered thereinto and engaged therewith,
wherein the alignment protruded portion is formed to have a tapered shape that has a bottom face extending in an expanding direction of the first workpiece and an inclined face inclined with respect to the bottom face,
wherein the alignment depressed portion is a depressed portion that extends in one direction to have a given length and whose cross-sectional shape is formed to have a V-shape including a pair of depressed-portion inclined faces inclined with respect to a thickness direction of the second workpiece, a protrusion that has a face extending in the thickness direction being formed in the middle of the length, and
wherein the first workpiece is aligned in an orthogonal manner with respect to the second workpiece, while engaging the alignment depressed portion is engaged with the alignment protruded portion, due to an alignment in which the inclined face of the alignment protruded portion contacts one of the pair of depressed-portion inclined faces and the bottom face of the alignment protruded portion contacts the face of the protrusion extending in the thickness direction.

4. An alignment structure comprising:
an alignment protruded portion formed to be protruded from an edge portion of a first workpiece that is a metal plate; and
an alignment depressed portion formed on a surface of a second workpiece such that the alignment protruded portion is entered thereinto and engaged therewith,
wherein the alignment protruded portion is formed to have a tapered shape that has a bottom face extending in a thickness direction of the first workpiece and an inclined face inclined with respect to the bottom face,
wherein the alignment depressed portion is a depressed portion that extends in one direction to have a given length and whose cross-sectional shape is formed to have a V-shape including a pair of depressed-portion inclined faces inclined with respect to a thickness direction of the second workpiece, a protrusion that has a face extending in the thickness direction of the second workpiece being formed in the middle of the length, and
wherein the first workpiece is aligned in a stacked manner with respect to the second workpiece, while engaging the alignment depressed portion is engaged with the alignment protruded portion, due to an alignment in which the inclined face of the alignment protruded portion contacts one of the pair of depressed-portion inclined faces and the bottom face of the alignment protruded portion contacts the face of the protrusion extending in the thickness direction.
